(19) United States
(12) Patent Application Publication
(10) Pub. No.: US 2016/0108612 A1
(43) Pub. Date: Apr. 21, 2016

(54) External insulation wall for mechanically-anchored inorganic modified foam insulation board with grid reinforcement

(71) Applicant: SHANGHAI ONE GOLD ENERGY-SAVING TECHNOLOGY CO. LTD., Shanghai (CN)

(72) Inventor: Jinlie Zhou, Shanghai (CN)

(21) Appl. No.: 14/778,100

(22) PCT Filed: Feb. 26, 2014
(86) PCT No.: PCT/CN2014/072552

§ 371 Date: Sep. 18, 2015

(30) Foreign Application Priority Data
Mar. 18, 2013 (CN) 201310088060.9

(51) Int. Cl. E04B 1/76; B32B 5/24; B32B 5/02; B32B 5/18; E04C 2/24; E04F 13/02

(52) U.S. Cl. CPC E04B 1/7625; E04C 2/243; E04B 1/7629; E04F 13/02; B32B 5/028; B32B 5/18; B32B 5/245; B32B 2262/101; B32B 2262/02; B32B 2262/103; B32B 2266/0214; B32B 2307/54; B32B 2307/546; B32B 2307/304; B32B 2607/00

(57) ABSTRACT

An external insulation wall for a mechanically-anchored inorganic modified foam insulation board with grid reinforcement includes, arranged sequentially from inside to out, a substrate (4), a leveling and combining layer (5), an inorganic modified foam insulation board with a grid reinforcement (6), a plastic expansion anchor bolt (7), a thin plaster protective layer (8) and a finishing coat (9), wherein the inorganic modified foam insulation board with a grid reinforcement (6) includes an inorganic modified foam insulation core board (1), a bidirectional grid reinforcement (2) and an inorganic modified foam insulation protective layer (3) with reinforcement. During construction, the leveling and combining layer (5) is used to perform the leveling of the base layer and the auxiliary bonding of the inorganic modified foam insulation board (6) with the grid reinforcement in one step.

### CROSS REFERENCE OF RELATED APPLICATION

This is a U.S. National Stage under 35 U.S.C 371 of the International Application PCT/CN2014/072552, filed Feb. 26, 2014, which claims priority under 35 U.S.C. 119(a-d) to CN 201310088060.9, filed Mar. 18, 2013.

### BACKGROUND OF THE PRESENT INVENTION

1. Field of Invention

The present invention relates to an insulation wall for a mechanically-anchored inorganic modified foam insulation board with grid reinforcement, which is particularly suitable for the energy-saving renovation project of the existing exterior wall.

2. Description of Related Arts

The conventional external insulation wall of an inorganic modified foam insulation board is a composite wall combined by a substrate of an external wall of a building and an inorganic modified foam insulation wall. The inorganic modified foam insulation layer, which serves as an insulating layer, is fixed on a substrate by adhesive. This kind of structure requires the adhesive to carry all loads of the external insulation system, and then all the loads are transmitted to the substrate by a wall leveling layer. However, a non-adhesive insulation board caused by the roughness of the substrate of a building or the insulation board may cause potential quality and security risk on the whole external insulation wall. In addition, while performing external thermal insulation energy-saving renovation on the external wall of the existing buildings, varying degrees of defects of the local decorative layer, such as the looseness, hollowness, cracks, dirt on the surface and isolating membrane, directly affect the stability and service safety of a newly adhesive external thermal insulation layer. Thus, it is necessary to improve the fixation method of the inorganic modified foam insulation board of the external wall surface.

Furthermore, the conventional inorganic modified foam insulation boards are generated by foaming the substrate of organic foam insulation board, moulding by a molding machinery, and then performing polymerization and modified curing utilizing inorganic fireproof materials. For example, Zhu, Chunling, Ji, Guangqi, “Architectural fireproof materials”, Chemical Industry Press of China, Beijing, July 2009 (1) discloses that: various existing techniques are capable of making polymeric materials to have flame retardant property, such as adding fire retardant, adding inorganic filler, blending, grafting and crosslinking with polymeric material having high inflammability to synthesize self-extinguishing high polymer. The inorganic fillers usually have high melting points and are relatively inactive in combustion. Filling a large amount of inorganic fillers in high polymers is capable of effectively improving the flame retardant property of the base material and meanwhile decreasing the costs of the products. Being identical to inorganic fire retardants, the fillers need surface modification, so as to improve the compatibility with resin. (See the last 11^{th} line to the end of the 22^{nd} page). When high polymers containing this kind of fire retardant are heated, a uniform and dense carbon-based foam layer is formed on the surface, which is capable of effectively isolating heat and oxygen, inhibiting fuming and preventing generation of the molten drop. Thus, the high polymers containing this kind of fire retardant have excellent inflaming retarding performance (See the last 9^{th} to 7^{th} lines on the 34^{th} page). At present, fireproof polyethylene can be added to inorganic aquo-complex such as aluminium hydroxide and magnesium hydroxide, which is not only capable of decreasing the costs of the products, but also eliminating the smoldering phenomenon (See the last 8-4^{th} lines on page 186). The manufacturing method of the fire-retardant polyurethane materials mainly includes adding various kinds of additive type fire retardant or inorganic filler, so as to modify the structure of the polyurethane material, i.e., utilizing polyhydric alcohols or isocyanate with fire-retardant elements as raw materials to synthesize fire-retardant polyurethane, and introducing the isocyanate into the molecular chain of the polyurethane is capable of improving the carbonization tendency of the materials and thereby reducing the flammability thereof. (See the 26-29^{th} lines on the page 249. Partly or totally replacing organic flammable filler in phenolic resin with inorganic inert filler is capable of improving the fire-retardant performance of the products (See the last second to the end on the page 301).

Since the characteristics of the inorganic modified foam insulation board is having satisfying density, thermal conductivity coefficient and combustion performance, but poor bending strength, tensile strength and folding strength, cracks, deformation and shrinkage easily occurs. When the inorganic modified foam insulation board is utilized in the mechanically-anchored wall of external insulation board, the anchored inorganic modified foam insulation board has drawbacks of high brittleness and easy fracture. Thus, improving the structure of the conventional inorganic modified foam insulation board is essential.

### SUMMARY OF THE PRESENT INVENTION

In order to overcome the drawbacks of non-adhesive and hollowing which may generated while adhering and fixing the inorganic modified foam insulation boards of the conventional external insulation wall, and of the low stability of the conventional inorganic modified foam insulation boards while being anchored by a mechanical fixing device. The present invention provides a mechanically-anchored inorganic modified foam insulation board with a grid reinforcement. The inorganic modified foam insulation board with a grid reinforcement 6 comprises an inorganic modified foam insulation board and a bidirectional grid reinforcement 2 sandwiched in a surface layer thereof, which is characterized in that: the inorganic modified foam insulation protective layer is adhered on an external surface of the bidirectional grid reinforcement 2, so as to improve tensile strength, bending strength and folding strength of the inorganic modified foam insulation board. The inorganic modified foam insulation board is an inorganic modified polyphenyl organic foam insulation board, an inorganic modified polyurethane organic foam insulation board, an inorganic modified polyurethane-polyisocyanurate organic foam insulation board or inorganic modified phenolic aldehyde organic foam board. In addition, an organic foam insulation board is performed with polymerization and modified curing treatment utilizing an inorganic fireproof filler, so as to improve fireproof performance of the organic foam insulation board. The mechanically-anchored external insulation wall is not only capable of solving problems of checking difficulties of non-adhering while fixing and maintenance difficulties, but also stabilizing and reinforcing the original finishing coat of conventional buildings. Furthermore, the construction process is simple and rapid.

Accordingly, in order to solve the technical problems mentioned above, a technical solution provided by the present invention is as follows.

Firstly, a bidirectional grid reinforcement 2 is provided on a surface layer of an inorganic modified foam insulation board. The bidirectional grid reinforcement 2 is glass fiber mesh, metal mesh or chemical fiber mesh. The inorganic modified foam insulation board is in a shape of a rectangular plane or a right-angle corner. The inorganic modified foam insulation board is characterized in that: an inorganic modified foam insulation protective layer 3 is adhered on an external surface of the bidirectional grid reinforcement 2, so as to isolate the grid reinforcement 2 from environment outside the board such as thin plaster mortar, and improve corrosion resistance and durability of the grid reinforcement 2. The bidirectional grid reinforcement 2 can be provided on double sides or a single side of the inorganic modified foam insulation board according to requirements. The right-angle corner board is suitable for corner parts of internal and external corners of an external wall, a broadside of a periphery of a door or window hole, or decorative moulding of a convex wall surface, so as to overcome the drawback that when a joint appears when joining and assembling an external insulation rectangular plane board on a corner of a wall surface, an anchor bolt is not suitable for straddle fixation, so as to ensure integral continuity of the external insulation wall.

A manufacturing process of the inorganic modified foam insulation board 6 with grid reinforcement of the present invention comprises steps of:

adhering the grid reinforcement 2 in a surface layer of the organic foam insulation boards and ensuring an integrality and an impermeability of the organic foam insulation boards on an internal side or an external side of the grid reinforcement 2, so as to manufacture an organic foam insulation board with grid reinforcement; and

adopting a crystal lattice node method comprising: in a sealed pressure chamber having a given temperature, taking advantage of pressure differences, uniformly permeating a solution containing an inorganic fireproof and fire-retardant filler into the organic foam insulation boards to perform polymerization and modified curing treatment, so as to fill and cover peripheries of foam particles of the organic foam insulation board with fireproof inorganic filler crystal particles and form a barrier to isolate atmosphere, so as to improve fireproof performance of the organic foam insulation board, wherein a combustion performance of the organic foam insulation board reaches a A2 level standard of incombustible material according to CN GB8624-2006.

The grid reinforcement made of the glass fiber mesh is formed by knitting decussations of glass fiber warps and wefts; a diameter of a grid aperture of the grid reinforcement made of the glass fiber is 5-20×5-20 mm, and preferably 7-15×7-15 mm; a thickness of a protective layer of the inorganic modified foam insulation board of the grid reinforcement, which is also a distance of the grid reinforcement to an external edge of a surface of the inorganic modified foam insulation board is 3-15 mm, and preferably 5-10 mm; an alkali-resisting tensile breaking strength of the grid reinforcement on a radial or weft direction is that: an ordinary type is greater than or equal to 1250N/50 mm, and an enhanced type is greater than or equal to 3000N/50 mm; a retention rate of the alkali-resisting tensile breaking strength is greater than or equal to 90%; the glass fiber mesh is alkali-resisting glass fiber mesh; the chemical fiber mesh is polyester fiber mesh, polyamide fiber mesh, polyacrylonitrile fiber mesh, polyving akohol fiber mesh or poly ethyreal; the grid reinforcement made of metal mesh is formed by electric welding decussations of longitudinal steel wires and transverse steel wires, the grid reinforcement made of metal mesh is hot-galvanized steel wire, cold drawn low carbon steel wire, stainless steel wire or alloy steel wire; a diameter of a grid aperture of the grid reinforcement made of the metal mesh is 5-35×5-35 mm, and preferably 12-25×12-25 mm diameter of the hot-galvanized steel wire, the cold drawn low carbon steel wire, the stainless steel wire or the alloy steel wire is 0.7-3.0 mm and preferably 0.9-2.5 mm; and a thickness of the protective layer of the inorganic modified foam insulation board of the grid reinforcement is at a range of 5-20 mm, and preferably 7-15 mm.

Secondly, a main construction process of the external insulation wall for mechanically-anchored inorganic modified foam insulation board with grid reinforcement comprises steps of:

spreading polymer mortar on a surface of the substrate 4 for serving as a leveling and combining layer; meanwhile the inorganic modified foam insulation board 6 with grid reinforcement is adhered on the wall to form an insulation layer without interspaces wherein the adhering is only used for ensuring the flatness during the installation of the inorganic foam insulation board 6 with grid reinforcement and the external insulation system;

when a bonding strength of the leveling and combining layer 5 is greater than or equal to 0.06 MPa, drilling a hole on a surface of the board and directly anchoring the inorganic modified foam insulation board 6 with the reinforcement on the substrate 4 of the external wall by the plastic expansion anchor bolt 7, so as to allow the mechanical fixing device of a plastic expansion anchor bolt 7 to bear all loads of the external insulation system, and transmit all the loads onto the substrate 4; and

coating crack proof mortar on a thin plaster protective layer 8 on an external surface of the inorganic modified foam insulation board 6 with the grid reinforcement and roller coating elastic coating on the finishing coat 9.

Furthermore, a thickness of the mortar of leveling and combining layer is at a range of 3-9 mm, so as to meet the requirements of the thickness of leveling and combining. An optimal anchoring distance of the plastic expansion anchor bolt 7 which is a mechanical fixing device provided uniformly on the inorganic modified foam insulation board 6 is at a range of 200-450×200-450 mm, and preferably 250-400×250-400 mm; an amount of the anchor bolt is greater than or equal to 8/m²; an effective anchoring depth of the plastic expansion anchor bolt is greater than or equal to 25 mm; a tension strength standard value of a single anchor bolt is greater than or equal to 0.6KN; a diameter of a plastic disc with a leak serving as a press board provided on an end portion of the anchor bolt is greater than or equal to 60 mm; so as to ensure the stability of the insulation board.

The present invention has following beneficial effects. Compared with the external insulation wall fixed by adhering in the conventional inorganic modified foam insulation boards, the present invention is capable of accomplishing leveling the substrate and auxiliarily adhering the inorganic modified foam insulation board with the grid reinforcement simultaneously at a time. The adhering is only used for ensuring the flatness during the installation of the inorganic modified foam insulation board with the grid reinforcement and the external insulation system, so as to decrease the construction procedure and period. The mechanical fixing device of a plastic expansion anchor bolt 7 anchors the inorganic modified foam insulation board 6 with the reinforcement, so as to allow the entire load of an external wall system and the wind power (sucking power) to be entirely supported by the plastic expansion anchor bolt 7 and then to be directly transferred onto the substrate 4. The construction process is simple and easy operating, and the construction quality is easy to control. The technique of the present invention is a new technique which is not disclosed from 1957 of the external wall insulation project of firstly adhering EPS polystyrene organic foam plastic board external wall in Berlin Germany. The combination of the inorganic modified foam board 6 with the grid reinforcement and a mechanical fixing device of the plastic expansion anchor bolt 7 greatly improves tensile strength, bending strength and folding strength of an insulation layer and is suitable for the external wall insulation projects of high-rise buildings with a height of not exceeding 100 m. The present invention is particularly suitable for energy saving reconstruction of insulation of an external wall of a conventional building, and is capable of effectively overcome drawbacks of insufficient adhering strength caused by partial protuberance shell, cracks or a surface contamination isolating membrane, so as to have a strengthening and protecting effect to improve a stability of the external insulation wall for mechanically-anchored inorganic modified foam insulation board.

### BRIEF DESCRIPTION OF THE DRAWINGS

Specific properties and performances of the present invention are further illustrated by the following detailed description and the accompanying drawings.

FIG. 1 is a structurally schematic view of an inorganic modified insulation board with grid reinforcement according to a preferred embodiment of the present invention.

FIG. 2 is a vertical sectional view of the FIG. 1.

FIG. 3 is a structurally schematic view of an external insulation wall for a mechanically-anchored inorganic modified foam insulation board with grid reinforcement.

FIG. 4 is a vertical sectional view of the FIG. 3.

FIG. 5 is vertical view of the mechanically-anchored inorganic modified foam insulation board with grid reinforcement.

In the drawings: 1-inorganic modified foam insulation core board; 2-grid reinforcement; 3-inorganic modified foam insulation protective layer with reinforcement; 4-substrate; 5-leveling and combining layer; 6-inorganic modified foam insulation board with a grid reinforcement; 7-plastic expansion anchor bolt; 8-thin plaster protective layer; 9-finishing coat; 10-vertical joint.

### DETAILED DESCRIPTION OF THE PREFERRED EMBODIMENT

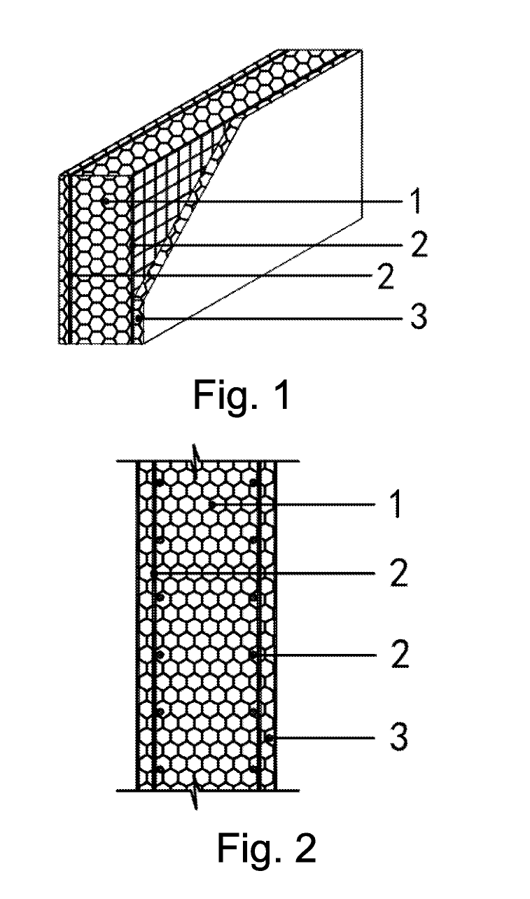

Referring to FIG. 1 and FIG. 2 of the drawings, an inorganic modified foam insulation board 6 with a grid reinforcement, arranged sequentially from inside to out, comprises: an inorganic modified foam insulation core board 1, a bidirectional grid reinforcement 2 and an inorganic modified foam insulation protective layer 3 with reinforcement. The inorganic modified foam insulation board is an inorganic modified polyphenyl organic foam insulation board, an inorganic modified polyurethane organic foam insulation board, an inorganic modified polyurethane-polyisocyanurate organic foam insulation board or inorganic modified phenolic aldehyde organic foam board. The inorganic modified polyphenyl organic foam insulation board can be an expanded polyphenylene board (EPS) or an extruded polystyrene board (XPS). The grid reinforcement 2 is formed by knitting decussations of glass fiber warps and wefts made of glass fiber or chemical fiber; or by electric welding decussations of longitudinal steel wires and transverse steel wires. The grid reinforcement 2 can be provided on double sides or a single side. The inorganic modified foam insulation protective layer 3 and the inorganic modified foam insulation core board 1 form an integral board, so as to isolate the grid reinforcement 2 from environment outside the board such as the thin plaster protective layer to prevent the reinforcement from alkalization and corrosion.

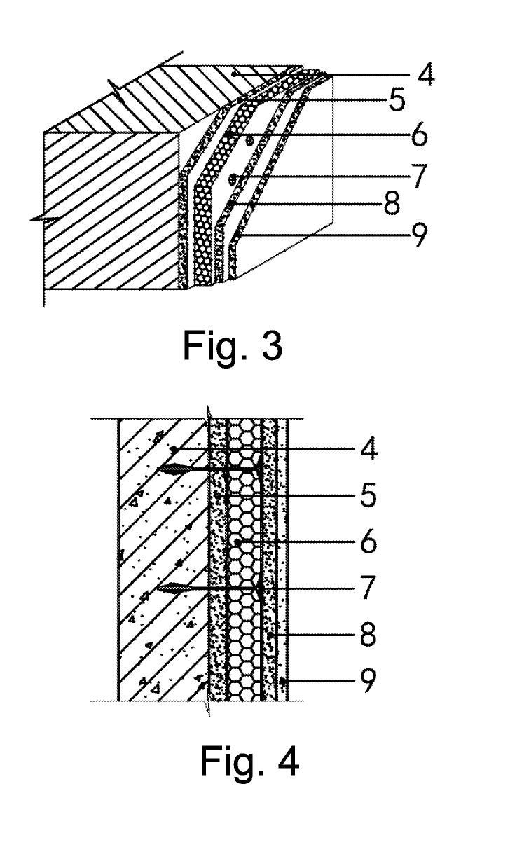

Referring to FIG. 3, the external insulation wall of the present invention utilizes an external wall of a building for serving as the substrate 4. The external insulation wall of the present invention comprises, arranged sequentially from inside to out, a substrate 4, a leveling and combining layer 5, an inorganic modified foam insulation board with 6 a grid reinforcement, a plastic expansion anchor bolt 7, a thin plaster protective layer 8 and a finishing coat 9. The substrate 4 is a concrete wall, an air-entrapping concrete building block wall, a solid brick wall, a hollow brick wall or a light weight cement bonded sand building block wall; the plastic expansion anchor bolt 7 comprises a plastic sleeve, a sleeve end portion plastic disc leak press board and round nails inside the sleeve, the plastic expansion anchor bolt 7 is a knock-on anchor bolt or a spiral anchor bolt; when the substrate 4 is a hollow brick wall, a spiral anchor bolt with a tightening back and knotting function, the sleeve and the sleeve end portion plastic disc leak press board of the plastic expansion anchor bolt are made of materials of polyamide, polyethylene or polypropylene. The thin plaster protective layer 8 comprises plastering crack proof mortar and alkali-resisting fiber glass mesh. The finishing coat 9 comprises a flexible putty, an investment precoat and overlay painting.

Referring to FIG. 4, polymer mortar of the leveling and combining layer 5 has a thickness at a range of 3-9 mm. While leveling the substrate 4, the inorganic modified foam insulation board 6 with the grid reinforcement is synchronously adhered on a wall, and a gird reinforcement 2 provided on a surface of the inorganic modified foam insulation board faces an outside of the wall, leveling the substrate 4 and auxiliarily adhering the inorganic modified foam insulation board with the grid reinforcement are accomplished simultaneously at a time; a bonding strength of the leveling and combining layer 5 is greater than or equal to 0.06 MPa, a hole is provided on the inorganic modified foam insulation board 6 to anchor the inorganic modified foam insulation board 6 on the substrate 4 utilizing a plastic expansion anchor bolt 7, an effective anchoring depth of the plastic expansion anchor bolt 7 is greater than or equal to 25 mm, and preferably 35-50 mm; a tension strength standard value of a single anchor bolt is greater than or equal to 0.6KN; a diameter of a plastic disc with a leak serving as a press board provided on an end portion of the anchor bolt is greater than or equal to 60 mm, and preferably 65-95 mm; then a thin plaster protective layer 8 is applied on the inorganic modified foam insulation board 6 with the grid reinforcement and cover the plastic expansion anchor bolt 7, so as to improve a bonding force between the thin plaster protective layer 8 and the inorganic modified foam insulation board 6; the thin plaster protective layer 8 adopts polymer crack proof mortar, an enhancing mesh is sandwiched in the thin plaster protective layer 8 and has effects of anti-cracking, water proofing and impact resistance; the finishing coat 9 is brushed on the thin plaster protective layer 8 by utilizing a flexible putty, a plastic surface painting and a plastic overlay painting are executed by layer.

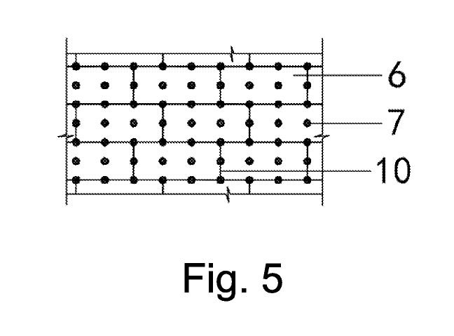

As shown in FIG. 5, a lay-up method of the inorganic modified foam insulation board 6 with the grid reinforcement comprising horizontally arranging rectangular boards from top to bottom, wherein vertical joints between the rectangular boards are staggered line by line, a distance of a staggered joint is greater than or equal to 200 mm, and optimal staggered joints are 300 mm and 400 mm, so as to allow full play to an anchoring effect of a straddle anchor bolt; a length of the inorganic modified foam insulation board with the grid reinforcement is at a range of 600 -2000 mm, and preferably 900-1600 mm; a width thereof is at a range of 300-1000mm and preferably 450-800 mm; and a thickness thereof is at a range of 15-180 mm and preferably 40-120 mm. The inorganic modified foam insulation board is in a shape of a rectangular plane or a right-angle corner. Boundary dimension of the right-angle corner board matches with an adjacent rectangular plane board in size and joints, a length of the right-angle corner board located on an external wall surface of a corner is greater than or equal to 280 mm, so as to satisfy that a distance from an anchor bolt straddle fixation position on a surface of the inorganic modified foam insulation board 6 to an edge of an external corner is greater than or equal to 100 mm; an insulation board utilized on an external side of a periphery of a hole of a door or a window adopts a whole right-angle corner board, so as to increase stability of the inorganic modified foam insulation board 6.

The plastic expansion anchor bolt 7 is installed on inorganic modified foam insulation board 6 and a straddle on an edge of the inorganic modified foam insulation board 6 by a nail; a horizontal installation anchoring distance of the anchor bolt on a vertical or a horizontal direction of the insulation board is at a range of 200-450×200-450 mm; an anchor bolts amount on a joint of a broadside is greater than or equal to 3, and a distances between the anchor bolts is lees than or equal to 400 mm; four corners of the inorganic modified foam insulation board 6 all have the anchor bolts provided thereon, and an arrangement distance between the anchor bolts are decreased with an increase of a height of the external insulation layer or a loaded wind power (sucking power), so as to ensure stability and security of an external insulation system of the inorganic modified foam insulation board with the grid reinforcement.

What is claimed is:

1. An inorganic modified foam insulation board with grid reinforcement, comprising: an inorganic modified foam insulation core board (1), a bidirectional grid reinforcement (2) and an inorganic modified foam insulation protective layer (3) with reinforcement to form the inorganic modified foam insulation board (6) with grid reinforcement arranged sequentially from inside to outside;
wherein the inorganic modified foam insulation protective layer (3) is adhered on an external surface of the bidirectional grid reinforcement (2), so as to improve tensile strength, bending strength and folding strength of the inorganic modified foam insulation board;
the bidirectional grid reinforcement (2) is glass fiber mesh, metal mesh or chemical fiber mesh, the bidirectional grid reinforcement (2) is provided on double sides or a single side of the inorganic modified foam insulation board;
the inorganic modified foam insulation board is an inorganic modified polyphenyl organic foam insulation board, an inorganic modified polyurethane organic foam insulation board, an inorganic modified polyurethane-polyisocyanurate organic foam insulation board or inorganic modified phenolic aldehyde organic foam board;
a manufacturing process of the inorganic modified foam insulation board (6) with the grid reinforcement adopts a method of achieving compression molding the grid reinforcement and organic foam insulation boards in one time, and comprises steps of:
adhering the grid reinforcement in a surface layer of the organic foam insulation boards and ensuring an integrality and an impermeability of the organic foam insulation boards on an internal side or an external side of the grid reinforcement, so as to manufacture an organic foam insulation board with grid reinforcement; and
in a sealed pressure chamber having a given temperature, taking advantage of pressure differences, uniformly permeating a solution containing an inorganic fireproof and fire-retardant filler into the organic foam insulation boards to perform polymerization and modified curing treatment, so as to fill and cover peripheries of foam particles of the organic foam insulation board with fireproof inorganic filler crystal particles and form a barrier to isolate atmosphere, so as to improve fireproof performance of the organic foam insulation board;
the inorganic modified foam insulation board (6) is in a shape of a rectangular plane board or a right-angle corner board, the right-angle corner board is suitable for corner parts of internal and external corners of an external wall, a broadside of a periphery of a door or window hole, or decorative moulding of a convex wall surface, so as to overcome the drawback that when a joint appears when joining and assembling an external insulation rectangular plane board on a corner of a wall surface, an anchor bolt is not suitable for straddle fixation, so as to ensure integral continuity of the external insulation wall;
the inorganic modified foam insulation board is suitable for allowing the entire load of an external wall system to be entirely supported by the plastic expansion anchor bolt and then to be directly transferred onto the substrate;
adhering the insulation board is only used for ensuring flatness during installation of the external insulation system, the combination of the inorganic modified foam board with the grid reinforcement and a mechanical fixing device of the plastic expansion anchor bolt greatly improves tensile strength, bending strength and folding strength of an insulation layer.

2. The inorganic modified foam insulation board with the grid reinforcement, as recited in claim 1, wherein grid reinforcement made of the glass fiber mesh is formed by knitting decussations of glass fiber warps and wefts; grid reinforcement made of the chemical fiber mesh is formed by knitting decussations of chemical fiber warps and wefts a diameter of a grid aperture of the grid reinforcement made of the glass fiber is 5-20×5-20 mm; a thickness of a protective layer of the inorganic modified foam insulation board of the grid reinforcement, which is also a distance of the grid reinforcement to an external edge of a surface of the inorganic modified foam insulation board is at a range of 3-15 mm; an alkali-resisting tensile breaking strength of the grid reinforcement on a radial or weft direction is that: an ordinary type is greater than or equal to 1250N/50 mm, and an enhanced type is greater than or equal to 3000N/50 mm; a retention rate of the alkali-resisting tensile breaking strength is greater than or equal to 90%; the glass fiber mesh is alkali-resisting glass fiber mesh; the chemical fiber mesh is polyester fiber mesh, polyamide fiber mesh, polyacrylonitrile fiber mesh, polyving akohol fiber mesh or poly ethyreal; the grid reinforcement made of metal mesh is formed by electric welding decussations of longitudinal steel wires and transverse steel wires, the grid reinforcement made of metal mesh is hot-galvanized steel wire, cold drawn low carbon steel wire, stainless steel wire or alloy steel wire; a diameter of a grid aperture of the grid reinforcement made of the metal mesh is 5-35×5-35 mm; a diameter of the hot-galvanized steel wire, the cold drawn low carbon steel wire, the stainless steel wire or the alloy steel wire is 0.7-3.0 mm; and a thickness of the protective layer of the unorganic modified foam insulation board of the grid reinforcement is at a range of 5-20 mm.

3. The inorganic modified foam insulation board with the grid reinforcement, as recited in claim 2, wherein an optimal distance of an aperture of the grid reinforcement made of the glass fiber mesh or the grid reinforcement made of the chemical fiber mesh is at a range of 7˜15×7˜15 mm; an optimal thickness of the inorganic modified foam insulation board of the grid reinforcement is at a range of 5-10 mm; an optimal distance of an aperture of the grid reinforcement made of the metal fiber mesh or the grid reinforcement made of the chemical fiber mesh is at a range of 12˜25×12˜25 mm; an optimal diameter of a steel wire is 0.9-2.5 mm, and an optimal thickness of the protective layer of the inorganic modified foam insulation board of the grid reinforcement is at a range of 7-15 mm.

4. An external insulation wall for mechanically-anchored inorganic modified foam insulation board with grid reinforcement, comprising, arranged sequentially from inside to out, a substrate (4), a leveling and combining layer (5), an inorganic modified foam insulation board with (6) a grid reinforcement, a plastic expansion anchor bolt (7), a thin plaster protective layer (8) and a finishing coat (9); wherein polymer mortar having a thickness at a range of 3-9 mm is covered on a surface of the substrate (4) to form the leveling and combining layer (5); while leveling the substrate (4), the inorganic modified foam insulation board (6) with the grid reinforcement is synchronously adhered on a wall, and a gird reinforcement (2) provided on a surface of the inorganic modified foam insulation board faces an outside of the wall, leveling the substrate (4) assists adhering the inorganic modified foam insulation board with the grid reinforcement and accomplishes simultaneously at a time; a bonding strength of the leveling and combining layer (5) is greater than or equal to 0.06 MPa, a hole is provided on the inorganic modified foam insulation board (6) to anchor the inorganic modified foam insulation board (6) on the substrate (4) utilizing a plastic expansion anchor bolt (7), an effective anchoring depth of the plastic expansion anchor bolt (7) is greater than or equal to 25 mm; a tension strength standard value of a single anchor bolt is greater than or equal to 0.6KN; a diameter of a plastic disc with a leak serving as a press board provided on an end portion of the anchor bolt is greater than or equal to 60 mm; then a thin plaster protective layer (8) is applied on the inorganic modified foam insulation board (6) with the grid reinforcement and cover the plastic expansion anchor bolt (7), so as to improve a bonding force between the thin plaster protective layer (8) and the inorganic modified foam insulation board (6); the thin plaster protective layer (8) adopts polymer crack proof mortar, an enhancing mesh is sandwiched in the thin plaster protective layer (8) and has effects of anti-cracking, water proofing and impact resistance; the finishing coat (9) is brushed on the thin plaster protective layer (8) by utilizing a flexible putty, a plastic surface painting and a plastic overlay painting are executed by layer; a lay-up method of the inorganic modified foam insulation board (6) with the grid reinforcement comprising horizontally arranging rectangular boards from top to bottom, vertical joints between among the rectangular boards is staggered line by line, a distance of a staggered joint is greater than or equal to 200 mm, and optimal staggered joints are 300 mm and 400 mm, so as to allow full play to an anchoring effect of a straddle anchor bolt; a length of the inorganic modified foam insulation board with the grid reinforcement is at a range of 600-2000 mm, a width thereof is at a range of 300-1000 mm and a thickness thereof is at a range of 15-180 mm;
wherein the inorganic modified foam insulation board (6) arranged sequentially from inside to out, comprising: an inorganic modified foam insulation core board (1), a bidirectional grid reinforcement (2) and an inorganic modified foam insulation protective layer (3) with reinforcement to form the inorganic modified foam insulation board (6) with grid reinforcement;
wherein the inorganic modified foam insulation protective layer (3) is adhered on an external surface of the bidirectional grid reinforcement (2), so as to improve tensile strength, bending strength and folding strength of the inorganic modified foam insulation board;
the bidirectional grid reinforcement (2) is glass fiber mesh, metal mesh or chemical fiber mesh, the bidirectional grid reinforcement (2) is provided on double sides or a single side of the inorganic modified foam insulation board;
the inorganic modified foam insulation board is an inorganic modified polyphenyl organic foam insulation board, an inorganic modified polyurethane organic foam insulation board, an inorganic modified polyurethane-polyisocyanurate organic foam insulation board or inorganic modified phenolic aldehyde organic foam board;
a manufacturing process of the inorganic modified foam insulation board (6) with the grid reinforcement adopts a method of achieving compression molding the grid reinforcement and organic foam insulation boards in one time, and comprises steps of:
adhering the grid reinforcement in a surface layer of the organic foam insulation boards and ensuring an integrality and an impermeability of the organic foam insulation boards on an internal side or an external side of the grid reinforcement, so as to manufacture an organic foam insulation board with grid reinforcement; and
in a sealed pressure chamber having a given temperature, taking advantage of pressure differences, uniformly permeating a solution containing an inorganic fireproof and fire-retardant filler into the organic foam insulation boards to perform polymerization and modified curing treatment, so as to fill and cover peripheries of foam particles of the organic foam insulation board with fireproof inorganic filler crystal particles and form a barrier to isolate atmosphere or oxygen, so as to improve fireproof performance of the organic foam insulation board;
the inorganic modified foam insulation board (6) is in a shape of a rectangular plane board or a right-angle corner board, the right-angle corner board is suitable for corner parts of internal and external corners of an external wall, a broadside of a periphery of a door or window hole, or decorative moulding of a convex wall surface, so as to overcome the drawback that when a joint appears when joining and assembling an external insulation rectangular plane board on a corner of a wall surface, an anchor bolt is not suitable for straddle fixation, so as to ensure integral continuity of the external insulation wall;
the inorganic modified foam insulation board is suitable for allowing the entire load of an external wall system to be entirely supported by the plastic expansion anchor bolt (7) and then to be directly transferred onto the substrate (4);
adhering the insulation board is only used for ensuring flatness during installation of the external insulation system, the combination of the inorganic modified foam board with the grid reinforcement and a mechanical fixing device of the plastic expansion anchor bolt greatly improves tensile strength, bending strength and folding strength of an insulation layer;
a boundary dimension of the right-angle corner board matches with an adjacent rectangular plane board in size and joints, a side length of the right-angle corner board located on an external wall surface of a corner is greater than or equal to 280 mm, so as to satisfy that a distance from an anchor bolt straddle fixation position on a surface of the inorganic modified foam insulation board (6) to an edge of an external corner is greater than or equal to 100 mm; an insulation board utilized on an external side of a periphery of a hole of a door or a window adopts a whole right-angle corner board, so as to increase stability of the inorganic modified foam insulation board (6); the plastic expansion anchor bolt (7) is installed on inorganic modified foam insulation board (6) and a straddle on an edge of the inorganic modified foam insulation board (6) by a nail; a horizontal installation anchoring distance of the anchor bolt on a vertical or a horizontal direction of the insulation board is at a range of 200-450×200-450 mm, an amount of the anchor bolts is greater than or equal to 8/m²; an anchor bolts amount on a joint of a broadside is greater than or equal to 3, and a distances between the anchor bolts is lees than or equal to 400 mm; four corners of the inorganic modified foam insulation board (6) all have the anchor bolts provided thereon, and an arrangement distance between the anchor bolts are decreased with an increase of a height of the external insulation layer or a loaded wind power, so as to ensure stability and security of an external insulation system of the inorganic modified foam insulation board with the grid reinforcement;
the external insulation wall for mechanically-anchored inorganic modified foam insulation board with grid reinforcement is suitable for external insulation projects of an external wall of high-rise buildings having a height lea than or equal to 100 m, and suitable for energy saving reconstruction of insulation of an external wall of a conventional building, and is capable of effectively overcome drawbacks of insufficient adhering strength caused by partial protuberance shell, cracks or a surface contamination isolating membrane, so as to have a strengthening and protecting effect to improve a stability of the external insulation wall for mechanically-anchored inorganic modified foam insulation board.

5. The external insulation wall for mechanically-anchored inorganic modified foam insulation board with grid reinforcement, as recited in claim 4, wherein an optimal length of the inorganic modified foam insulation board with the grid reinforcement is at a range of 900-1600, a width thereof is at a range of 450-800 mm and a thickness thereof is at a range of 40-120 mm, an optimal anchoring distance of the plastic expansion anchor bolt provided on a vertical or a horizontal direction of the inorganic modified foam insulation board is at a range of 250-400×250-400 mm, an optimal effective anchoring depth of the anchor bolt is at a range of 35-50 mm, and an optimal diameter of the plastic disc with the leak serving as the press board provided on the end portion of the anchor bolt is at a range of 65-95 mm.

6. The external insulation wall for mechanically-anchored inorganic modified foam insulation board with grid reinforcement, as recited in claim 4, wherein the substrate is a concrete wall, an air-entrapping concrete building block wall, a solid brick wall, a hollow brick wall or a light weight cement bonded sand building block wall; the plastic expansion anchor bolt comprises a plastic sleeve, a sleeve end portion plastic disc leak press board and round nails inside the sleeve, the plastic expansion anchor bolt is a knock-on anchor bolt or a spiral anchor bolt; when the substrate is a hollow brick wall, a spiral anchor bolt with a tightening back and knotting function, the sleeve and the sleeve end portion plastic disc leak press board of the plastic expansion anchor bolt are made of materials of polyamide, polyethylene or polypropylene.
